(19) United States
(12) Patent Application Publication
(10) Pub. No.: US 2020/0356285 A1
(43) Pub. Date: Nov. 12, 2020

(54) PASSWORD PROTECTED DATA STORAGE DEVICE AND CONTROL METHOD FOR NON-VOLATILE MEMORY

(71) Applicant: Silicon Motion, Inc., Zhubei City (TW)

(72) Inventors: Hung-Ting PAN, Taoyuan City (TW); Chih-Yu LIN, Zhubei City (TW); Sung-Ling HSU, New Taipei City (TW)

(21) Appl. No.: 16/508,517

(22) Filed: Jul. 11, 2019

(30) Foreign Application Priority Data
May 10, 2019 (TW) 108116307

(51) Int. Cl. G06F 3/06; H04L 9/08

(52) U.S. Cl. CPC G06F 3/0622; H04L 9/088; G06F 3/0679; G06F 3/0655

(57) ABSTRACT

A security mechanism of non-volatile memory. The controller encrypts a privilege password and stores the encrypted privilege password in a non-volatile memory. Before being stored in the non-volatile memory, a key used to encrypt data for data storage on the non-volatile memory may be encrypted using a Key Encryption Key (KEK). The KEK may be used in the encryption of the privilege password, so that the non-volatile memory stores the privilege password and the KEK in ciphertext. In response to the matched privilege password, the KEK is obtained to decrypt the encrypted key for decryption of (user) data.

### CROSS REFERENCE TO RELATED APPLICATIONS

This Application also claims priority of Taiwan Patent Application No. 108116307, filed on May 10, 2019, the entirety of which is incorporated by reference herein.

### BACKGROUND OF THE INVENTION

### Field of the Invention

The present invention is related to data security of non-volatile memory.

### Description of the Related Art

There are various forms of non-volatile memory (NVM) for long-term data storage, such as flash memory, magnetoresistive RAM, ferroelectric RAM, resistive RAM, spin transfer torque-RAM (STT-RAM), and so on. These non-volatile memories may be used as the storage medium in a data storage device.

How to improve the data security of non-volatile memory is an important issue in the technical field.

### BRIEF SUMMARY OF THE INVENTION

In accordance with an exemplary embodiment of the present invention, a data storage device includes a non-volatile memory and a controller. The controller operates the non-volatile memory as requested by a host. The controller encrypts a first privilege password and stores the encrypted first privilege password in the non-volatile memory. The security of privilege password is significantly improved.

In an exemplary embodiment, the controller encrypts a first section of data using a first key and stores the encrypted first section of data in the non-volatile memory. The controller encrypts the first key using a first key encryption key and stores the encrypted first key in the non-volatile memory.

In an exemplary embodiment, the controller encrypts the first privilege password using the first key encryption key and stores first ciphertext generated by the first privilege password and the first key encryption key. In response to an access request that matches the first privilege password, the controller decrypts the first ciphertext and obtains the first key encryption key, performs decryption based on the first key encryption key to obtain the first key, and performs decryption based on the first key to obtain the first section of data.

In an exemplary embodiment, the controller includes components for implementing encryption logic. The controller combines the components to implement a first encryption algorithm, and encrypts the first privilege password according to the first encryption algorithm. The controller combines the components to implement a second encryption algorithm that is different from the first encryption algorithm, and encrypts the first key according to the second encryption algorithm.

In an exemplary embodiment, the controller encrypts a second section of data using a second key and stores the encrypted second section of data in the non-volatile memory. The controller encrypts the second key using a second key encryption key and stores the encrypted second key in the non-volatile memory. The controller encrypts a second privilege password using the second key encryption key and stores second ciphertext generated by the second privilege password and the second key encryption key. In response to an access request that matches the second privilege password, the controller decrypts the second ciphertext and obtains the second key encryption key, performs decryption based on the second key encryption key to obtain the second key, and performs decryption based on the second key to obtain the second section of data. In an exemplary embodiment, the controller includes a random number generator, generating the first key encryption key for the first key, and generating the second key encryption key for the second key. In an exemplary embodiment, the controller includes components for implementing encryption logic. The controller combines the components to implement a first encryption algorithm, and encrypts the first privilege password according to the first encryption algorithm. The controller combines the components to implement a second encryption algorithm that is different from the first encryption algorithm, and encrypts the second privilege password according to the second encryption algorithm.

In an exemplary embodiment, the controller encrypts a second privilege password and stores the encrypted second privilege password in the non-volatile memory. The controller isolates encryption of the first privilege password from encryption of the second privilege password. In an exemplary embodiment, the controller includes a random number generator, generating a first password encryption key for the first privilege password, and generating a second password encryption key that is different from the first privilege password for the second privilege password. In an exemplary embodiment, the controller includes components for implementing encryption logic. The controller combines the components to implement a first encryption algorithm, and encrypts the first privilege password according to the first encryption algorithm. The controller combines the components to implement a second encryption algorithm that is different from the first encryption algorithm, and encrypts the second privilege password according to the second encryption algorithm.

In an exemplary embodiment, the controller uses a first key encryption key to encrypt a first key, wherein the first key is used to encrypt data accessed through the first privilege password. The controller further uses the first key encryption key to encrypt the first privilege password. The controller uses a second key encryption key to encrypt a second key, wherein the second key is used to encrypt data accessed through the second privilege password. The controller further uses the second key encryption key to encrypt the second privilege password.

The concept of present invention may be further used to implement a non-volatile memory control method.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting a data storage device 100 in accordance with an exemplary embodiment of the present invention, wherein a data security solution for a flash memory 102 is introduced;

FIG. 2 illustrates the concept of security storage in accordance with an exemplary embodiment of the present invention; and

FIG. 3 is a flowchart depicting how to cope with an access request for the flash memory 102 in accordance with an exemplary embodiment of the present invention.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

A non-volatile memory for long-term data retention may be a flash memory, a magnetoresistive RAM, a ferroelectric RAM, a resistive RAM, a spin transfer torque-RAM (STT-RAM) and so on. The following discussion uses flash memory as an example.

Today's data storage devices often use flash memory as the storage medium for storing user data from the host. There are many types of data storage devices, including memory cards, USB flash devices, SSDs, and so on. In another exemplary embodiment, a flash memory may be packaged with a controller to form a multiple-chip package called eMMC.

A data storage device using a flash memory as a storage medium can be applied in a variety of electronic devices, including a smartphone, a wearable device, a tablet computer, a virtual reality device, etc. A calculation module of an electronic device may be regarded as a host that operates a data storage device equipped on the electronic device to access a flash memory within the data storage device.

A data center may be built with data storage devices using flash memories as the storage medium. For example, a server may operate an array of SSDs to form a data center. The server may be regarded as a host that operates the SSDs to access the flash memories within the SSDs.

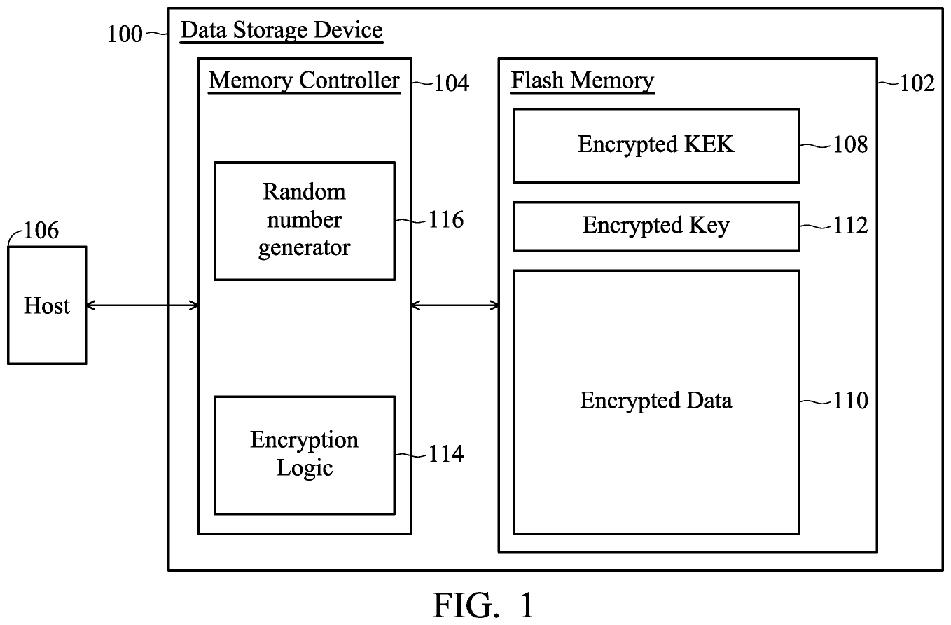

FIG. 1 is a block diagram depicting a data storage device 100 in accordance with an exemplary embodiment of the present invention, preferably using a flash memory 102 as a storage medium. A memory controller 104 of the data storage device 100 operates the flash memory 102 in accordance with host commands issued by a host 106. The present invention provides a data security solution for the data storage device 100.

The data storage device 100 may store data for different privileges. To access the data stored in the data storage device 100, a matched privilege password is required. For example, an administrator enters administrator password that is different from the password for a general user. The data accessing performed by an administrator, therefore, is separated from the data accessing performed by a general user. A matched privilege password is necessary to gain the data accessing right. When the privilege password is stored in the flash memory 102 in plaintext, a hacker can gain the access right of data as long as the storage location of the privilege password is found. To deal with this problem, the memory controller 104 encrypts the privilege password and stores the privilege password in the flash memory 102 in ciphertext, so that the security of the privilege password is significantly improved. In another exemplary embodiment, the privilege password is kept at the administrator side or the user side, and is only loaded into the data storage device 100 when needed. It is more difficult for the hacker to steal the privilege password from the administrator or user side.

The memory controller 104 also directly performs a security procedure on the user data (or data) to be written to the flash memory 102. The memory controller 104 encrypts the data issued by the host 106 before storing it in the flash memory 102. As shown in FIG. 1, the flash memory 102 stores encrypted data 110. The key for data encryption/decryption is also encrypted by the memory controller 104 before being stored in the flash memory 102 (referring to the encrypted key 112 stored in the flash memory 102). Even if the hacker gets the encrypted key 112 from the flash memory 102, the encrypted key 112 is still protected. The hacker cannot get the right key to decrypt the encrypted data 110. The data security is significantly improved and guaranteed. The encryption of the key depends on a Key Encryption Key (KEK).

Because the data security highly depends on the KEK, a security procedure performed on the KEK will considerably improve the security of user data. In an exemplary embodiment, the memory controller 104 encrypts the KEK based on privilege password. In this manner, not only the KEK is protected, the privilege password is also protected. The KEK is combined with the privilege password and then stored in the flash memory 102 in ciphertext. KEK can be regarded the key to encrypt the privilege password. The privilege password can also be considered as the key to encrypt the KEK. To read data from the flash memory 102, the matched privilege password has to be provided with a host command issued by the host 106. The encrypted KEK 108 is decrypted by the memory controller 104 based on the matched privilege password, and thereby the KEK is obtained. The memory controller 104 uses the KEK to decrypt the encrypted key 112 and use the decrypted key to decrypt the encrypted data 110. The data in plaintext, therefore, is obtained. The privilege password may be directly indicated by the host command. In another exemplary embodiment, the host 106 provides a privilege password in response to the execution of the host command. When the privilege password does not match, the decryption of the KEK fails. There is no way to decrypt the encrypted key 112. Without the correct key, the hacker fails to decrypt the encrypted data 110. High data security is achieved by the present invention.

For the higher data security, the memory controller 104 preferably uses the different encryption algorithms to generate the encrypted KEK 108 and the encrypted key 112. In an exemplary embodiment, the memory controller 104 includes a block of encryption logic components 114, which includes logic elements/circuits operated according to a program. The memory controller 104 may use the back of encryption logic components 114 to form two or more different encryption algorithms. Data encryption, key encryption, and KEK encryption may take different encryption algorithms. The different privilege passwords may be encrypted using different encryption algorithms. With this design, the encryption complexity is increased and it is less susceptible to being cracked by hackers.

The memory controller 104 further includes a random number generator 116. The KEK may be generated by the random number generator 116.

The memory controller 104 may encrypt data using an Advanced Encryption Standard (AES) algorithm to generate the encrypted data 110 to be written to the flash memory 102. The data decryption is also based on the AES algorithm.

According to TCG OPAL (a storage device security management specification), the AES algorithm may be used in the encryption of multiple ranges of data. To achieve the higher data security, the different ranges of data are preferably encrypted using different keys. For example, the memory controller 104 encrypts the first section of data with the first key and the second section of data with the second key, and then writes the encrypted first section of data or the encrypted second section of data into the flash memory 102 as the encrypted data 110. The first section of data and the second section of data belong to different locking ranges. For example, the first section of data is in the locking range #1, and the second section of data is in the locking range #2. If the third section of data is not in any locking range, that is, in the global range. The memory controller 104 encrypts the third section of data with the third key and writes the encrypted third section of data to the flash memory 102. The memory controller 104 encrypts the first key or the second key with the same KEK to form the encrypted key 112, and then stores the encrypted key 112 in the flash memory 102. In order to simplify the description, only the first section of data and the second section of data are exemplified in the following, but are not limited thereto.

Upon receiving a host command (e.g., a read command), and the memory controller 104 decrypts the encrypted KEK 108 according to the privilege password input with the host command. When the privilege password is correct, the memory controller 104 successfully gets the KEK. Thereafter, the memory controller 104 decrypts the encrypted key 112 in accordance with the KEK to obtain the first key or the second key. The memory controller 104 decrypts the encrypted data 110 according to the obtained first key or second key. The memory controller 104, therefore, obtains the first section of data or the second section of data to respond to the host command.

In addition to the KEK, the random number generator 116 may further generate the first key and the second key.

In an exemplary embodiment, the first key and the second key are encrypted using the same KEK. In another exemplary embodiment, the first key and the second key may be encrypted using the different KEKs. Each KEK may be combined with a corresponding privilege password to be protected in a ciphertext form.

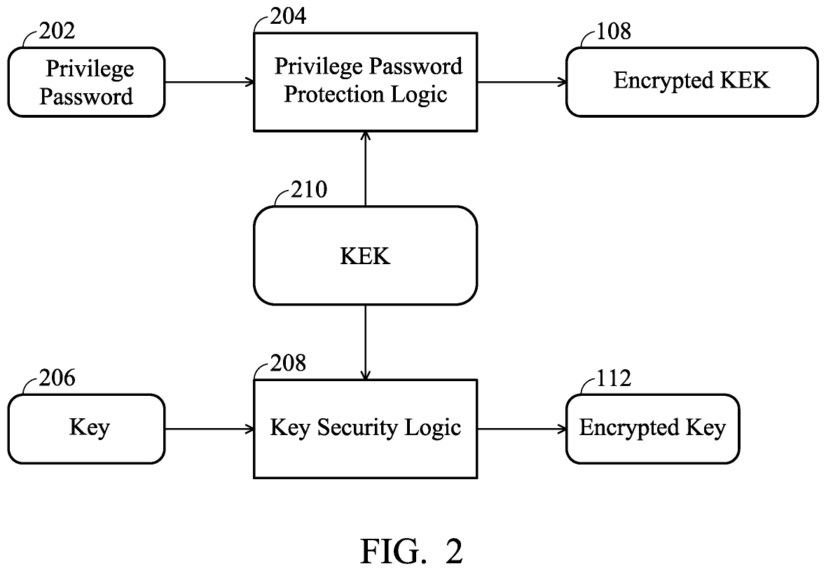

Generally, the administrator and the general user use the different privilege passwords. The privilege password security logic (e.g. referring to 204 of FIG. 2) uses the different privilege passwords to encrypt the same KEK and, therefore, generates the different encryption results (108). Although the same KEK is adopted, the different privilege passwords are well protected.

FIG. 2 illustrates the concept of security storage in accordance with an exemplary embodiment of the present invention. According to the privilege password security logic 204, the KEK 210 is encrypted by using the privilege password 202 to generate the encrypted KEK 108. Conversely, the encrypted KEK 108 is decrypted according to the privilege password protection logic 204 based on the privilege password 202 and thereby the KEK 210 is obtained. Additionally, according to the key security logic 208, a key 206 is encrypted using the KEK 210 to generate the encrypted key 112. Conversely, the encrypted key 112 is decrypted by the KEK 210 according to the key security logic 208 and thereby the key is obtained. The memory controller 104 uses the key to encrypt data or decrypt data. The different locking ranges preferably correspond to the different keys.

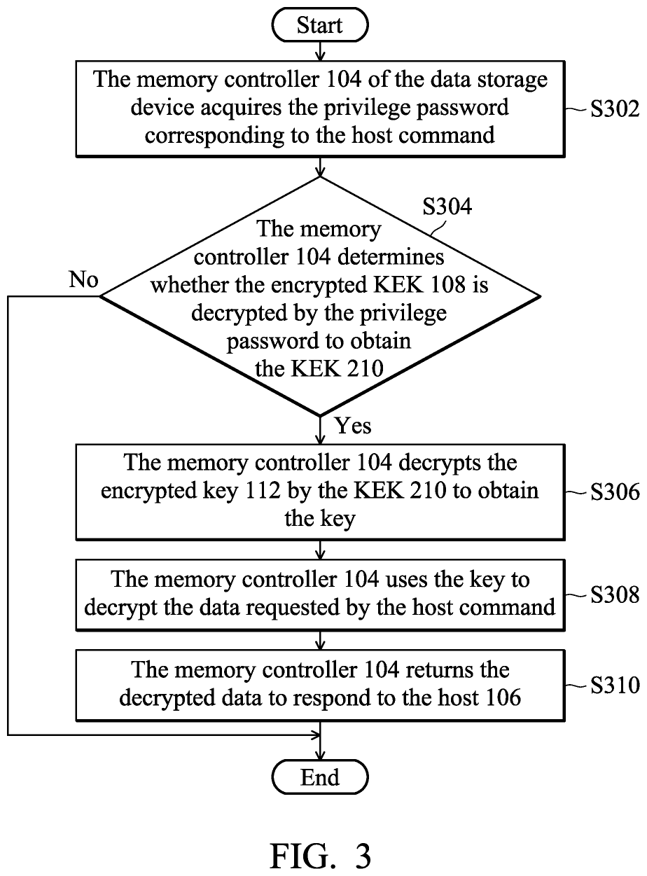

FIG. 3 is a flowchart depicting how the data storage device 100 responds to a host command from the host 106. The host command may be a read command. In step S302, the memory controller 104 of the data storage device acquires the privilege password corresponding to the host command. In step S304, the memory controller 104 determines whether the encrypted KEK 108 is decrypted by the privilege password to obtain the KEK 210. When the decryption fails, the host command is not executed, and the data storage device may send a warning message to the host 106. When the KEK 210 is successfully decrypted, step S306 is performed. The memory controller 104 decrypts the encrypted key 112 by the KEK 210 to obtain the key. In step S308, the memory controller 104 uses the key to decrypt the data requested by the host command. In step S310, the memory controller 104 returns the decrypted data to respond to the host 106.

A flash memory control method based on the aforementioned techniques is also within the technical scope of the present invention.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a non-volatile memory; and
a controller, operating the non-volatile memory as requested by a host, wherein:
the controller encrypts a first privilege password and stores the encrypted first privilege password in the non-volatile memory.

2. The data storage device as claimed in claim 1, wherein:
the controller encrypts a first section of data using a first key and stores the encrypted first section of data in the non-volatile memory; and
the controller encrypts the first key using a first key encryption key and stores the encrypted first key in the non-volatile memory.

3. The data storage device as claimed in claim 2, wherein:
the controller encrypts the first privilege password using the first key encryption key and stores first ciphertext generated by the first privilege password and the first key encryption key; and
in response to an access request that matches the first privilege password, the controller decrypts the first ciphertext and obtains the first key encryption key, performs decryption based on the first key encryption key to obtain the first key, and performs decryption based on the first key to obtain the first section of data.

4. The data storage device as claimed in claim 3, wherein:
the controller combines the components to implement a first encryption algorithm, and encrypts the first privilege password according to the first encryption algorithm; and
the controller combines the components to implement a second encryption algorithm that is different from the first encryption algorithm, and encrypts the first key according to the second encryption algorithm.

5. The data storage device as claimed in claim 3, wherein:
the controller encrypts a second section of data using a second key and stores the encrypted second section of data in the non-volatile memory;
the controller encrypts the second key using a second key encryption key and stores the encrypted second key in the non-volatile memory;
the controller encrypts a second privilege password using the second key encryption key and stores second ciphertext generated by the second privilege password and the second key encryption key; and
in response to an access request that matches the second privilege password, the controller decrypts the second ciphertext and obtains the second key encryption key, performs decryption based on the second key encryption key to obtain the second key, and performs decryption based on the second key to obtain the second section of data.

6. The data storage device as claimed in claim 5, wherein:
the controller includes a random number generator, generating the first key encryption key for the first key, and generating the second key encryption key for the second key.

7. The data storage device as claimed in claim 5, wherein:
the controller combines the components to implement a first encryption algorithm, and encrypts the first privilege password according to the first encryption algorithm; and
the controller combines the components to implement a second encryption algorithm that is different from the first encryption algorithm, and encrypts the second privilege password according to the second encryption algorithm.

8. The data storage device as claimed in claim 1, wherein:
the controller encrypts a second privilege password and stores the encrypted second privilege password in the non-volatile memory; and
the controller isolates encryption of the first privilege password from encryption of the second privilege password.

9. The data storage device as claimed in claim 8, wherein:
the controller includes a random number generator, generating a first password encryption key for the first privilege password, and generating a second password encryption key that is different from the first privilege password for the second privilege password.

10. The data storage device as claimed in claim 8, wherein:
the controller includes components for implementing encryption logic;
the controller combines the components to implement a first encryption algorithm, and encrypts the first privilege password according to the first encryption algorithm; and
the controller combines the components to implement a second encryption algorithm that is different from the first encryption algorithm, and encrypts the second privilege password according to the second encryption algorithm.

11. The data storage device as claimed in claim 8, wherein:
the controller uses a first key encryption key to encrypt a first key, wherein the first key is used to encrypt data accessed through the first privilege password;
the controller further uses the first key encryption key to encrypt the first privilege password;
the controller uses a second key encryption key to encrypt a second key, wherein the second key is used to encrypt data accessed through the second privilege password; and
the controller further uses the second key encryption key to encrypt the second privilege password.

12. A non-volatile memory control method, comprising:
operating a non-volatile memory as requested by a host; and
encrypting a first privilege password and storing the encrypted first privilege password in the non-volatile memory.

13. The non-volatile memory control method as claimed in claim 12, further comprising:
encrypting a first section of data using a first key and storing the encrypted first section of data in the non-volatile memory; and
encrypting the first key using a first key encryption key and storing the encrypted first key in the non-volatile memory.

14. The non-volatile memory control method as claimed in claim 13, further comprising:
encrypting the first privilege password using the first key encryption key and storing first ciphertext generated by the first privilege password and the first key encryption key; and
in response to an access request that matches the first privilege password, decrypting the first ciphertext and obtaining the first key encryption key, performing decryption based on the first key encryption key to obtain the first key, and performing decryption based on the first key to obtain the first section of data.

15. The non-volatile memory control method as claimed in claim 14, further comprising:
providing components for implementing encryption logic;
combining the components to implement a first encryption algorithm, and encrypting the first privilege password according to the first encryption algorithm; and
combining the components to implement a second encryption algorithm that is different from the first encryption algorithm, and encrypting the first key according to the second encryption algorithm.

16. The non-volatile memory control method as claimed in claim 14, further comprising:
encrypting a second section of data using a second key and storing the encrypted second section of data in the non-volatile memory;
encrypting the second key using a second key encryption key and storing the encrypted second key in the non-volatile memory;
encrypting a second privilege password using the second key encryption key and storing second ciphertext generated by the second privilege password and the second key encryption key; and
in response to an access request that matches the second privilege password, decrypting the second ciphertext and obtaining the second key encryption obtain the second key, and performing decryption based on the second key to obtain the second section of data.

17. The non-volatile memory control method as claimed in claim 16, further comprising:
providing a random number generator to generate the first key encryption key for the first key, and generate the second key encryption key for the second key.

18. The non-volatile memory control method as claimed in claim 16, further comprising:
providing components for implementing encryption logic;
combining the components to implement a first encryption algorithm, and encrypting the first privilege password according to the first encryption algorithm; and
combining the components to implement a second encryption algorithm that is different from the first encryption algorithm, and encrypting the second privilege password according to the second encryption algorithm.

19. The non-volatile memory control method as claimed in claim 12, further comprising:
encrypting a second privilege password and storing the encrypted second privilege password in the non-volatile memory; and
isolating encryption of the first privilege password from encryption of the second privilege password.

20. The non-volatile memory control method as claimed in claim 19, further comprising:
providing a random number generator, generating a first password encryption key for the first privilege password, and generating a second password encryption key that is different from the first privilege password for the second privilege password.

21. The non-volatile memory control method as claimed in claim 16, further comprising:
providing components for implementing encryption logic;
combining the components to implement a first encryption algorithm, and encrypting the first privilege password according to the first encryption algorithm; and
combining the components to implement a second encryption algorithm that is different from the first encryption algorithm, and encrypting the second privilege password according to the second encryption algorithm.

22. The non-volatile memory control method as claimed in claim 19, further comprising:
using a first key encryption key to encrypt a first key, wherein the first key is used to encrypt data accessed through the first privilege password;
using the first key encryption key to encrypt the first privilege password;
using a second key encryption key to encrypt a second key, wherein the second key is used to encrypt data accessed through the second privilege password; and
using the second key encryption key to encrypt the second privilege password.
